(19) United States
(12) Patent Application Publication
(10) Pub. No.: US 2014/0368171 A1
(43) Pub. Date: Dec. 18, 2014

(54) VEHICLE POWER GENERATION CONTROL DEVICE

(71) Applicant: DENSO CORPORATION, Kariya-city (JP)

(72) Inventor: Fuyuki MAEHARA, Nagoya (JP)

(21) Appl. No.: 14/308,247

(22) Filed: Jun. 18, 2014

(30) Foreign Application Priority Data
Jun. 18, 2013 (JP) 2013-127367

(51) Int. Cl. H02P 9/14

(52) U.S. Cl. CPC H02P 9/14
USPC 322/59

(57) ABSTRACT

A vehicle power generation control device receives a first limit value related to restriction of an excitation current, which flows to a field winding of a vehicle power generator, when the first limit value is transmitted from an external device. By the vehicle power generation control device, a second limit value related to restriction of the excitation current is determined to be a control value for the excitation current. The second limit value is held in an own vehicle power generation control device. By the vehicle power generation control device, the first limit value is determined to be the control value, instead of the second limit value being the control value, when the first limit value is received. Based on the control value, the vehicle power generation control device controls the excitation current flowing to the field winding.

### CROSS-REFERENCE TO RELATED APPLICATION

This application is based on and claims the benefit of priority from Japanese Patent Application No. 2013-127367, filed Jun. 18, 2013, the disclosure of which is incorporated herein in its entirety by reference.

### BACKGROUND

1. Technical Field

The present invention relates to a vehicle power generation control device that performs power generation control of a vehicle power generator that is mounted in a vehicle such as an automobile and a truck.

2. Related Art

In related art, a regulator has been known that has a power-saving function (refer to, for example, JP-B-3865157). The regulator restricts the power generation amount of a vehicle power generator by restricting excitation current based on the vehicle state and the power generator state. In this regulator, battery voltage, temperature, alternator rotation speed, and field current are detected. Based on the detected field current, a duty cycle of a switching element composed of a transistor, which drives the field current, is increased or decreased.

When appropriate power saving is performed by the above-described regulator disclosed in JP-B-3865157, constants are required to be changed depending on the vehicle power generators and vehicles that are to be combined. The constants are, for example, the rotation speed and the limit value at which restriction of the power generation amount is started. A problem occurs in that it is difficult to perform appropriate power saving for each combination of vehicle power generator and engine. Providing regulators that have differing specifications for each combination has been considered. However, providing regulators in correspondence with all combinations is unrealistic in terms of demands for cost reduction and the like.

### SUMMARY

It is thus desired to provide a vehicle power generation control device that is capable of performing appropriate restriction of the power generation amount in relation to the combination of vehicle power generator and vehicle.

An exemplary embodiment provides a vehicle power generation control device that includes communication means, excitation current control value determining means, and excitation current control means. The communication means receives a first limit value that is related to restriction of an excitation current, when the first limit value is transmitted from an external device. The excitation current control value determining means determines a second limit value that is related to restriction of the excitation current that is held in the own device to be a control value for the excitation current. In addition, the excitation current control value determining means determines the first limit value to be the control value, instead of the second limit value, when the first limit value is received by the communication means. The excitation current control means controls the excitation current flowing to a field winding of a vehicle power generator using the control value that has been determined by the excitation current control value determining means.

As a result of the first limit value being transmitted from the external device, the excitation current in the vehicle power generator can be restricted regardless of the magnitude of the second limit value that is held in the own device. Therefore, even when numerous combinations of vehicle power generators and vehicles are present, appropriate restriction of the power generation amount can be performed for each combination.

### BRIEF DESCRIPTION OF THE DRAWINGS

In the accompanying drawings:

FIG. 1 is a diagram of a configuration of a vehicle power generator according to a first embodiment;

FIG. 2 is a diagram of an example of power generation control using a maximum excitation current value that is determined based on a second limit value that is held in the own device;

FIG. 3 is a diagram of an example of power generation control using a maximum excitation current value that is determined based on a received first limit value;

FIG. 4 is a diagram of a configuration of a vehicle power generator according to a second embodiment;

FIG. 5 is a diagram of a configuration of a vehicle power generator according to a third embodiment;

FIG. 6 is a diagram of an example of power generation control using a maximum excitation current value or a maximum conduction ratio that is determined based on a second limit value that is held in an own vehicle power generation control device; and

FIG. 7 is a diagram of an example of power generation control using a maximum excitation current value or a maximum conduction ratio that is determined based on a received first limit value.

### DESCRIPTION OF EMBODIMENTS

A vehicle power generator according to embodiments to which the present invention is applied will be described in detail with reference to the drawings.

### First Embodiment

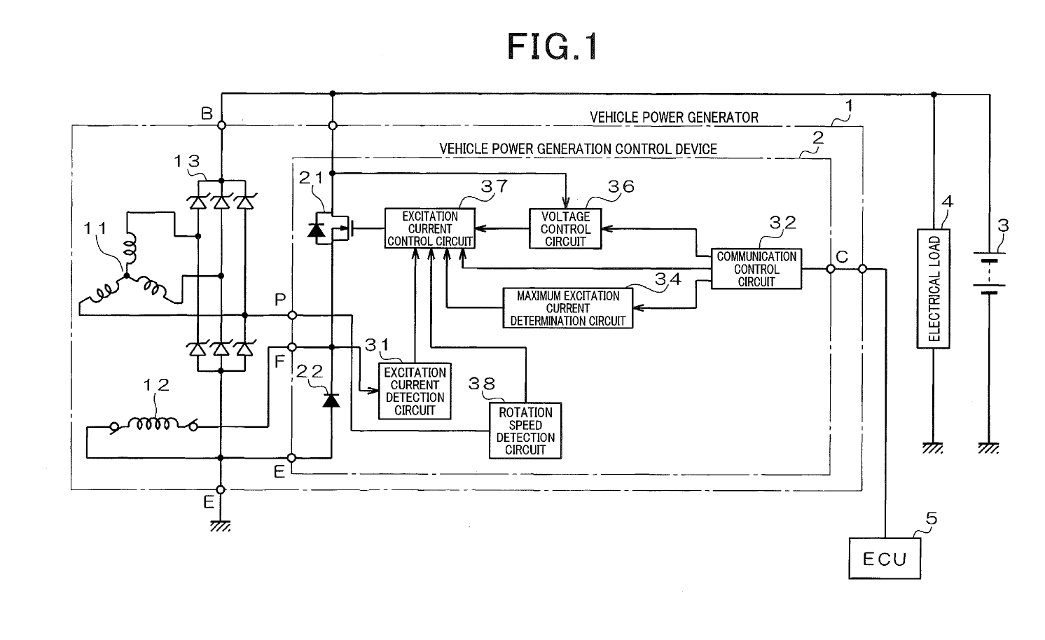

As shown in FIG. 1, a vehicle power generator 1 according to a first embodiment includes a vehicle power generation control device 2, an armature winding 11, a field winding 12, and a rectifying device 13. The vehicle power generator 1 is driven by an engine, via a belt and a pulley.

The field winding 12 is energized and generates a magnetic field. The field winding 12 is wound around a field pole (not shown) and configures a rotor. The armature winding 11 is a multi-phase winding (such as a three-phase winding). The armature winding 11 is wound around an armature core and configures an armature (stator). The armature winding 11 generates electromotive force due to a rotating field generated by the field winding 12. An alternating-current output induced by the armature winding 11 is supplied to the rectifying device 13.

The rectifying device 13 is a full-wave bridge rectifier circuit composed of, for example, six Zener diodes. The rectifying device 13 performs full-wave rectification of the alternating-current output from the armature winding 11. The output from the rectifying device 13 is taken outside from the output terminal (B terminal) of the vehicle power generator 1. The output is then supplied to a battery 3 and an electrical load 4. The output from the vehicle power generator 1 changes depending on the rotation speed of the rotor and the conduction amount of the excitation current flowing to the field winding 12. The excitation current is controlled by the vehicle power generation control device 2.

Next, details of the vehicle power generation control device 2 will be described. The vehicle power generation control device 2 includes a switching element 21, a freewheeling diode 22, an excitation current detection circuit 31, a communication control circuit 32, a maximum excitation current determination circuit 34, a voltage control circuit 36, an excitation current control circuit 37, and a rotation speed detection circuit 38.

The switching element 21 has a gate, a drain, and a source. The gate is connected to the excitation current control circuit 37. The drain is connected to the B terminal of the vehicle power generator 1. The source is connected to an E terminal (ground terminal) via the freewheeling diode 22. In addition, the source of the switching element 21 is connected to the field winding 12 via an F terminal. When the switching element 21 is turned on, the excitation current flows to the field winding 12. When the switching element 21 is turned off, energization is stopped. The freewheeling diode 22 is connected in parallel with the field winding 12. When the switching element 21 is turned off, the freewheeling diode 22 circulates the excitation current flowing to the field winding 12.

The excitation current detection circuit 31 detects the value of the excitation current flowing to the field winding 12. For example, the excitation current detection circuit 31 may be disposed in parallel with the switching element 21. Thus, a portion of the excitation current is branched into a separate flow. The excitation current detection circuit 31 detects the value of the separate flow, and estimates the value of the excitation current from the detection result. Alternatively, a resistor (not shown) for excitation current detection may be inserted in series with the switching element 21. The excitation current detection circuit 31 may then detect the excitation current based on the voltage across the resistor.

The communication control circuit 32 transmits and receives various signals to and from an electronic control unit (ECU) 5. The ECU 5 serves as an external device that is connected to the vehicle power generation control device 2 via a communication terminal (C terminal) and a signal line. Transmission and reception of signals is preferably performed by digital communication to suppress the effects of noise. The ECU 5 transmits pieces of setting information (such as an adjusting voltage setting value, a first limit value, and information on whether or not gradual excitation control is performed) that are required for power generation control. The setting information is received by the communication control circuit 32.

The maximum excitation current determination circuit 34 determines a second limit value that is held within the vehicle power generation control device 2 to be a maximum excitation current value (corresponding to an upper limit value of the excitation current). In addition, when a first limit value is received from the ECU 5 by the communication control circuit 32, the maximum excitation current determination circuit 34 determines the first limit value to be the maximum excitation current value, instead of the second limit value.

As the second limit value, a certain value unrelated to the rotation speed may be provided. Alternatively, a plurality of values depending on the rotation speed detected by the rotation speed detection circuit 38 may be provided (the values may change in stages, the values may continuously change, or the values may change in combination of both). The second limit value is stored in a storage device, such as a semiconductor memory (not shown).

In addition, when information indicating that the excitation current is not to be restricted is received from the ECU 5, the maximum excitation current determination circuit 34 determines the second limit value to be the maximum excitation current value. Furthermore, when communication between the ECU 5 and the communication control circuit 32 is interrupted, the maximum excitation current determination circuit 34 determines the second limit value to be the maximum excitation current value.

The voltage control circuit 36 compares the output voltage (B terminal voltage) of the vehicle power generator 1 with a predetermined adjusting voltage setting value. When the B terminal voltage is lower, the voltage control circuit 36 outputs an instruction (high-level signal) to supply the excitation current to the field winding 12.

The excitation current control circuit 37 turns on and off the switching element 21 depending on the output signal from the voltage control circuit 36. Specifically, when the output signal from the voltage control circuit 36 is held high, the excitation current control circuit 37 drives the switching element 21 such that the value of the excitation current detected by the excitation current detection circuit 31 does not exceed the maximum excitation current value determined by the maximum excitation current determination circuit 34.

In addition, when the output signal from the voltage control circuit 36 is held low, the excitation current control circuit 37 turns off the switching element 21. When the switching element 21 is driven by the excitation current control circuit 37, the excitation current or a duty cycle (also called a conducting ratio) of the switching element 21 at this time may be gradually increased. Gradual excitation control (load response control) may be performed in which sudden increase in power generation torque is suppressed.

The rotation speed detection circuit 38 detects the rotation speed of the engine or the power generator 1. Specifically, the rotation speed detection circuit 38 detects the rotation speed of the vehicle power generator 1 (power generator rotation speed) or an engine rotation speed based on at least one of the amplitude or the frequency of any phase voltage of the armature winding 11 inputted via the P terminal. The engine rotation speed corresponds one-to-one with the power generator rotation speed.

The communication control circuit 32 corresponds with a communication means. The maximum excitation current determination circuit 34 corresponds with an excitation current control value determining means. The excitation current control circuit 37 corresponds with an excitation current control means. The rotation speed detection circuit 38 corresponds with a rotation speed detecting means.

The vehicle power generator 1 according to the first embodiment is configured as described above. Next, detailed examples of the maximum excitation current value determined by the maximum excitation current determination circuit 34 of the vehicle power generation control device 2 will be described.

(1) When the second limit value is used when communication is not possible or the like:

As described above, in the vehicle power generation control device 2, when the information indicating that the excitation current is not to be restricted is received from the ECU 5, or when communication between the ECU 5 and the communication control circuit 32 is interrupted, the second limit value that is held in the own device is determined to be the maximum excitation current value.

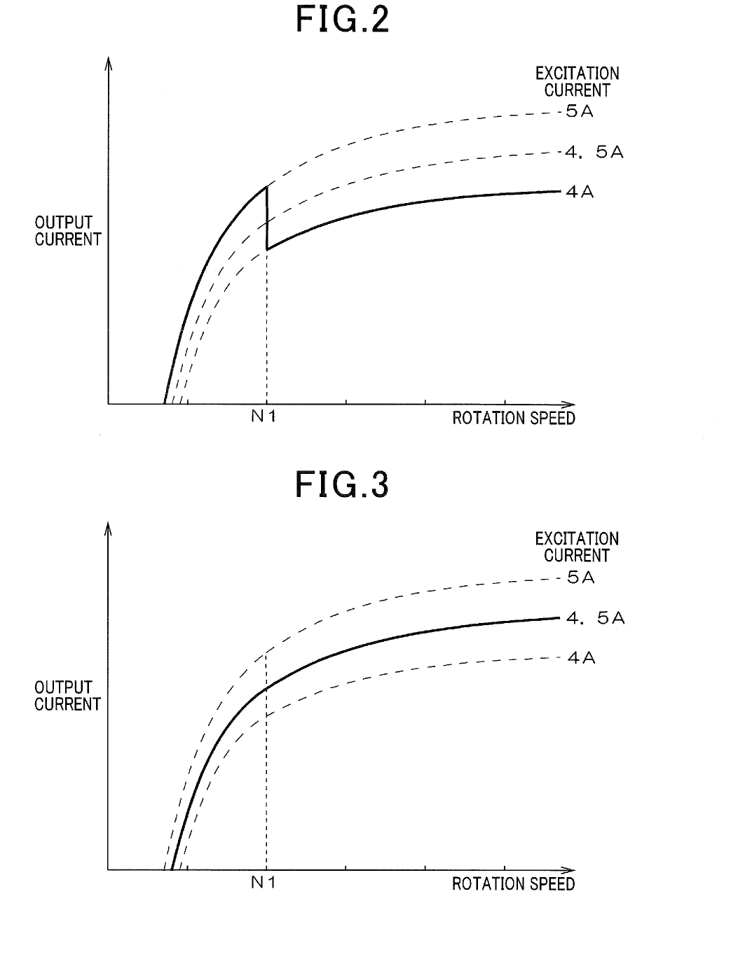

In the example shown in FIG. 2, as the second limit value, 5A (for example, corresponding to a 100% on-duty cycle of the switching element 21) is set for a rotation speed of less than N1. In addition, 4A (for example, corresponding to an 80% on-duty cycle of the switching element 21) is set for a rotation speed of N1 or higher. As a result of such settings, the power generation amount can be increased during low rotation when output is low. Conversely, the power generation amount can be reduced during high rotation, thereby preventing excessive output.

In the example shown in FIG. 2, two values are set as the second limit value with the rotation speed N1 as the border. However, three or more values may be set as the second limit value with two or more rotation speeds as the borders. In addition, a single value may be used as the second limit value for the overall rotation speed range.

(2) When the first limit value is used based on an instruction from the ECU 5:

In the vehicle power generation control device 2, when the first limit value is received from the ECU 5, the received first limit value is determined to be the maximum excitation current value, instead of the second limit value that is held within the own device.

In the example shown in FIG. 3, as the first limit value, 4.5 A (for example, corresponding with a 90% on-duty cycle of the switching element 21) is set for the overall rotation speed range. In the example shown in FIG. 3, a single value is set as the first limit value for the overall rotation speed range. However, in a manner similar to that of the second limit value shown in FIG. 2, two, or three or more values may be used that change depending on the rotation speed. In this instance, the rotation speed at which the first limit value changes maybe set accordingly on the ECU 5 side based on the type of vehicle power generator 1 and the type of vehicle (engine).

As described above, in the vehicle power generation control device 2 according to the first embodiment, as a result of the ECU 5 transmitting the first limit value, restriction of the excitation current in the vehicle power generator 1 can be performed regardless of the magnitude of the second limit value that is held in the own device. Therefore, even when numerous combinations of the vehicle power generator 1 and vehicles are present, appropriate restriction of the power generation amount can be performed for each combination.

In addition, when the information indicating that the excitation current is not to be restricted is received from the ECU 5, the second limit value is determined to be the maximum excitation current value.

As a result, even when a function for restricting the excitation current in the vehicle power generator 1 is not provided on the ECU 5 side, or when the function cannot be used as a result of an abnormality occurring within the ECU 5, restriction of the excitation current can be performed using the second limit value that is held in the vehicle power generation control device 2. In this way, as a result of an alternative restriction of excitation current being performed, reliability of a system including the vehicle power generator 1, the vehicle power generation control device 2, and the ECU 5 can be improved.

In addition, when communication between the ECU 5 and the communication control circuit 32 is interrupted, the second limit value is determined to be the maximum excitation current value.

As a result, even when communication with the ECU 5 cannot be performed, restriction of the excitation current can be performed using the second limit value that is held within the vehicle power generation control device 2. In this way, as a result of an alternative restriction of excitation current being performed, reliability of the system including the vehicle power generator 1, the vehicle power generation control device 2, and the ECU 5 can be improved.

In addition, even when power generation suppression is performed through excitation current restriction by the vehicle power generation control device 2, by power generation control being performed using the second limit value as the upper limit value of the excitation current (maximum excitation current value), switching of control by the ECU 5 becomes possible.

In addition, as a result of power generation control being performed using the first limit value as the upper limit value of the excitation current (maximum excitation current value), switching by the ECU 5 by excitation current restriction can be supported. A highly accurate power generation torque control by the ECU 5 becomes possible.

In addition, the second limit value that is held in the vehicle power generation control device 2 is a value based on the rotation speed. Therefore, even when the setting of the first limit value by the ECU 5 is not performed, power generation control can be performed in which the second limit value is variably changed based on the rotation speed.

### Second Embodiment

According to the above-described first embodiment, an instance is described in which a first or second limit value is designated and determined to be the maximum excitation current value. Power generation control is performed such that the excitation current does not exceed the maximum excitation current value. However, the first or second limit value may be set as a maximum conduction ratio (corresponding to an upper limit value of a conduction ratio) of the field winding 12. Power generation control maybe performed so as not to exceed the maximum conduction ratio.

Here, the conduction ratio of the field winding 12 is the proportion of time during which the excitation current flows in the field winding 12 through the switching element 21 that has been turned on. The conduction ratio is also referred to as the duty cycle of the switching element 21. The duty cycle is also called duty factor or duty ratio or on-duty ratio.

Hereinafter, the conduction ratio is referred to as “Fduty” that denotes the on-duty ratio of 0% to 100%. The maximum conduction ratio is referred to as “maximum Fduty”.

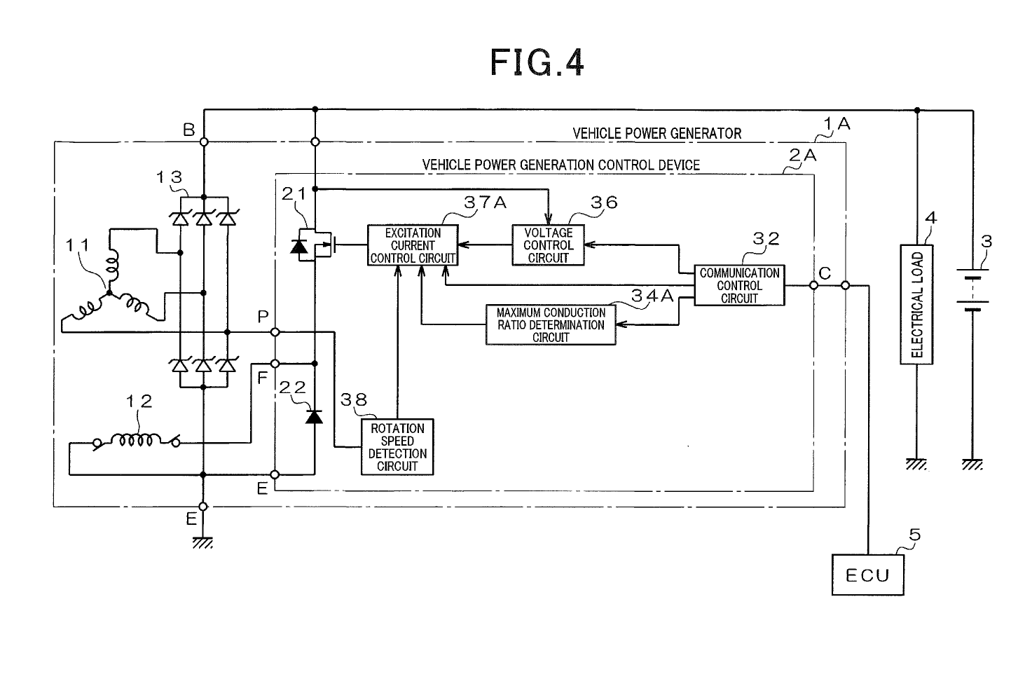

In relation to the vehicle power generator 1 shown in FIG. 1, a vehicle power generator 1A according to a second embodiment shown in FIG. 4 has a configuration in which the vehicle power generation control device 2 is replaced by a vehicle power generation control device 2A. In addition, in relation to the vehicle power generation control device 2 shown in FIG. 1, the vehicle power generation control device 2A has a configuration in which the excitation current detection circuit 31 is eliminated, the maximum excitation current determination circuit 34 is replaced by a maximum conduction ratio (Fduty) determination circuit 34A, and the excitation current control circuit 37 is replaced by an excitation current control circuit 37A.

The maximum conduction ratio determination circuit 34A determines the second limit value that is held in the vehicle power generation control device 2A to be the maximum conduction ratio (i.e., maximum Fduty). In addition, when the first limit value is received from the ECU 5 by the communication control circuit 32, the maximum conduction ratio determination circuit 34A determines the first limit value to be the maximum conduction ratio, instead of the second limit value.

In a manner similar to that according to the first embodiment, as the second limit value, a certain value unrelated to the rotation speed may be provided. Alternatively, a plurality of values depending on the rotation speed detected by the rotation speed detection circuit 38 may be provided (the values may change in stages, the values may continuously change, or the values may change in combination of both). The second limit value is stored in a storage device, such as a semiconductor memory (not shown). In addition, when information indicating that the excitation current is not to be restricted is received from the ECU 5, the maximum conduction ratio determination circuit 34A determines the second limit value to be the maximum conduction ratio. Furthermore, when communication between the ECU 5 and the communication control circuit 32 is interrupted, the maximum conduction ratio determination circuit 34A determines the second limit value to be the maximum conduction ratio.

The excitation current control circuit 37A turns on and off the switching element 21 depending on the output signal from the voltage control circuit 36. Specifically, when the output signal from the voltage control circuit 36 is held high, the excitation current control circuit 37A drives the switching element 21 such that the on-duty cycle (conduction ratio) of the switching element 21 does not exceed the maximum conduction ratio determined by the maximum conduction ratio determination circuit 34A.

In addition, when the output signal from the voltage control circuit 36 is held low, the excitation current control circuit 37A turns off the switching element 21. When the switching element 21 is driven by the excitation current control circuit 37A, the excitation current or the conduction ratio of the switching element 21 at this time may be gradually increased. Gradual excitation control (load response control) may be performed in which sudden increase in power generation torque is suppressed. The above-described maximum conduction ratio determination circuit 34A corresponds with the excitation current control value determining means.

The vehicle power generator 1A according to the second embodiment is configured as described above. Next, detailed examples of the maximum conduction ratio determined by the maximum conduction ratio determination circuit 34A of the vehicle power generation control device 2A will be described.

(1) When the second limit value is used when communication is not possible or the like:

As described above, in the vehicle power generation control device 2A, when the information indicating that the excitation current is not to be restricted is received from the ECU 5, or when communication between the ECU 5 and the communication control circuit 32 is interrupted, the second limit value that is held in the own device is determined to be the maximum conduction ratio.

(2) When the first limit value is used based on an instruction from the ECU 5:

In the vehicle power generation control device 2A, when the first limit value is received from the ECU 5, the received first limit value is determined to be the maximum conduction ratio, instead of the second limit value that is held in the own device.

As described above, in the vehicle power generation control device 2A according to the second embodiment, even when power generation suppression is performed through excitation current restriction by the vehicle power generation control device 2A, by power generation control being performed using the second limit value as the maximum conduction ratio, switching of control by the ECU 5 becomes possible.

In addition, as a result of power generation control being performed using the first limit value as the maximum conduction ratio, switching by the ECU 5 by excitation current restriction can be supported. A highly accurate power generation torque control by the ECU 5 becomes possible.

### Third Embodiment

According to the above-described first embodiment, power generation control is performed by the maximum excitation current value being determined According to the above-described second embodiment, the power generation control is performed by the maximum conduction ratio being determined. However, the maximum excitation current value and the maximum conduction ratio may be combined.

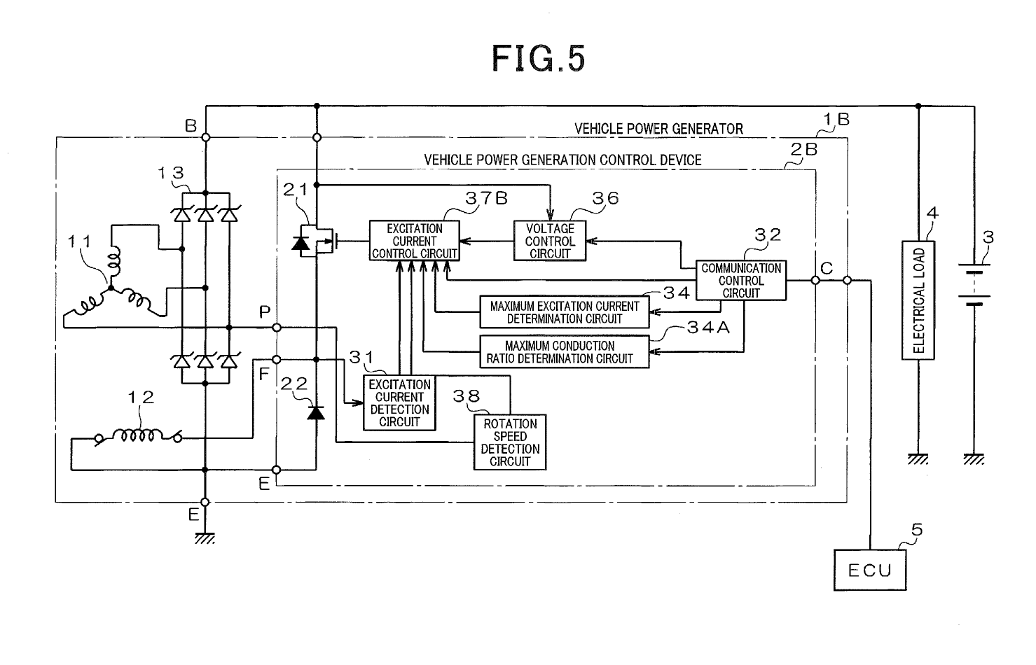

In relation to the vehicle power generator 1 shown in FIG. 1, a vehicle power generator 1B according to a third embodiment shown in FIG. 5 has a configuration in which the vehicle power generation control device 2 is replaced by a vehicle power generation control device 2B. In addition, in relation to the vehicle power generation control device 2 shown in FIG. 1, the vehicle power generation control device 2B has a configuration in which the maximum conduction ratio determination circuit 34A is added, and the excitation current control circuit 37 is replaced by an excitation current control circuit 37B.

The maximum conduction ratio determination circuit 34A is basically the same as that included in the vehicle power generation control device 2A according to the second embodiment. The maximum conduction ratio determination circuit 34A determines the second limit value that is held in the vehicle power generation control device 2B to be the maximum conduction ratio (i.e., maximum Fduty). When the first limit value is received from the ECU 5 by the communication control circuit 32, the maximum conduction ratio determination circuit 34A determines the first limit value to be the maximum conduction ratio, instead of the second limit value.

The vehicle power generation control device 2B according to the third embodiment includes both the maximum excitation current determination circuit 34 and the maximum conduction ratio determination circuit 34A. Therefore, the vehicle power generation control device 2B is capable of separately using the maximum excitation current value and the maximum conduction ratio depending on the rotation speed, by selectively using the two determination circuits 34 and 34A.

For example, when the information indicating that the excitation current is not to be restricted is received from the ECU 5, or when communication between the ECU 5 and the communication control circuit 32 is interrupted, the second limit value may be designated and determined to be the maximum excitation current value by the maximum excitation current determination circuit 34 for a predetermined rotation speed or lower. The second limit value may be designated and determined to be the maximum conduction ratio by the maximum conduction ratio determination circuit 34A for a rotation speed range that is higher than the predetermined rotation speed.

The excitation current control circuit 37B turns on and off the switching element 21 depending on the output signal from the voltage control circuit 36. Specifically, when the output signal from the voltage control circuit 36 is held high, the excitation current control circuit 37B drives the switching element 21 such that the value of the excitation current detected by the excitation current detection circuit 31 does not exceed the maximum excitation current value determined by the maximum excitation current determination circuit 34.

Alternatively, when the output signal from the voltage control circuit 36 is held high, the excitation current control circuit 37B drives the switching element 21 such that the on-duty cycle (conduction ratio) of the switching element 21 does not exceed the maximum conduction ratio determined by the maximum conduction ratio determination circuit 34A.

In addition, when the output signal from the voltage control circuit 36 is held low, the excitation current control circuit 37B turns off the switching element 21. When the switching element 21 is driven by the excitation current control circuit 37B, the excitation current or the conduction ratio of the switching element 21 at this time may be gradually increased. Gradual excitation control (load response control) may be performed in which sudden increase in power generation torque is suppressed. The above-described maximum Fduty determination circuit 34A corresponds with the excitation current control value determining means.

The vehicle power generator 1B according to the third embodiment is configured as described above. Next, detailed examples of the maximum excitation current value determined by the maximum excitation current determination circuit 34 and the maximum conduction ratio determined by the maximum Fduty determination circuit 34A of the vehicle power generation control device 2B will be described.

(1) When the second limit value is used when communication is not possible or the like:

As described above, in the vehicle power generation control device 2B, when the information indicating that the excitation current is not to be restricted is received from the ECU 5, or when communication between the ECU 5 and the communication control circuit 32 is interrupted, the second limit value that is held in the own device is determined to be the maximum excitation current value or the maximum conduction ratio.

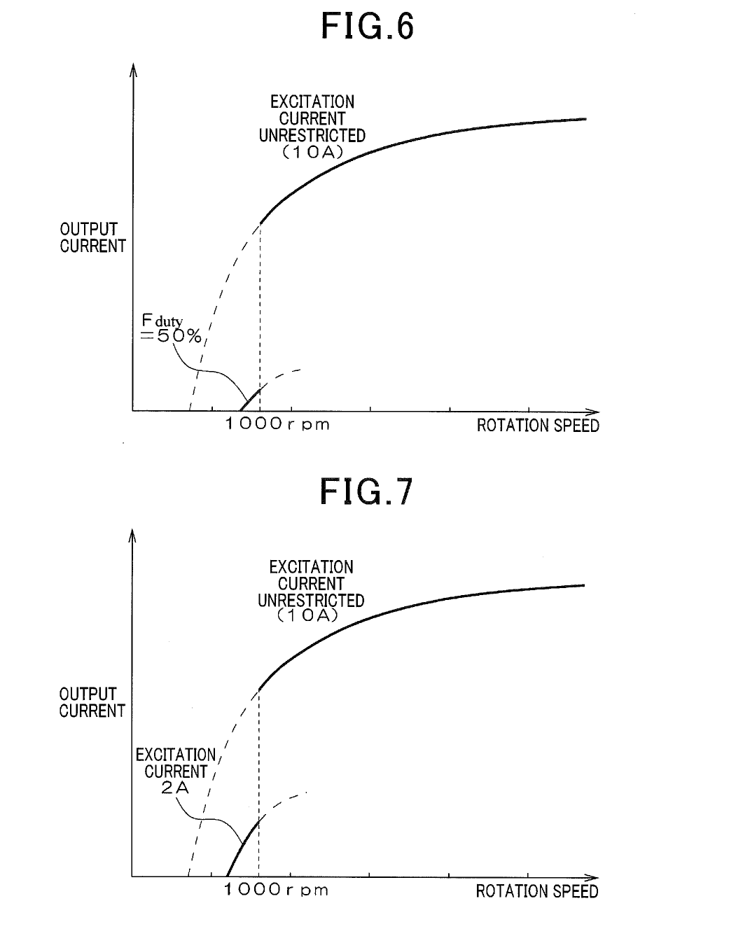

In the example shown in FIG. 6, as the second limit value, 15% is set as the maximum conduction ratio (Fduty; on-duty ratio of the switching element 21) for a rotation speed of less than 1000 rpm. An unlimited value (for example, actually 10 A which indicates an unrestricted excitation current) is set as the maximum excitation current value for a rotation speed of 1000 rpm or higher. As a result of such settings, a small initial excitation current can be set and power generation can be suppressed at engine startup. After engine startup, power generation suppression is no longer performed.

In the example shown in FIG. 6, the maximum excitation current is unrestricted for the rotation speed of 1000 rpm or higher. However, a similar power generation control may be performed with the maximum conduction ratio at 100% for the rotation speed of 1000 rpm or more.

(2) When the first limit value is used based on an instruction from the ECU 5:

In the vehicle power generation control device 2B, when the first limit value is received from the ECU 5, the received first limit value is determined to be the maximum conduction ratio, instead of the second limit value that is held within the own device.

In the example shown in FIG. 7, as the first limit value, 2 A is set as the maximum excitation current value for a rotation speed of less than 1000 rpm. An unlimited value (such as 10 A) is set as the maximum excitation current value for a rotation speed of 1000 rpm or higher. As a result of such settings, a small initial excitation current can be set and power generation can be suppressed at engine startup, based on an instruction from the ECU 5. After engine startup, power generation suppression is no longer performed. As described with reference to FIG. 6, a similar power generation control may be performed with the maximum conduction ratio at 100% for the rotation speed of 1000 rpm or higher, based on an instruction from the ECU 5.

As described above, in the vehicle power generation control device 2B according to the third embodiment, even when power generation suppression is performed through excitation current restriction or conduction ratio restriction by the vehicle power generation control device 2B, using the second limit value that is held in the own device, switching of control by the ECU 5 becomes possible.

In addition, as a result of power generation control being performed using the first limit value transmitted from the ECU 5 as the maximum excitation current value or the maximum conduction ratio, switching by the ECU 5 by excitation current restriction or conduction ratio restriction can be supported. A highly accurate power generation torque control by the ECU 5 becomes possible.

In particular, as a result of using the maximum conduction ratio as the second limit value and using the maximum excitation current value as the first limit value, regarding independent power generation suppression for which an instruction is not given from the ECU 5, the degree of suppression of the power generator can be at a certain proportion regardless of the type of power generator, even when the vehicle power generation control device 2B does not hold information on characteristics depending on the type of power generator.

When power generation suppression is performed based on an instruction from the ECU 5, power generation suppression can be performed based on the information on characteristics depending on the type of power generator held in the ECU 5, without being significantly affected by the temperature of the power generator. Highly accurate power generation suppression can be performed without increasing the number of types of vehicle power generation control devices.

The present invention is not limited to the above-described embodiments. Various modified embodiments are possible within the scope of the present invention. According to the above-described embodiments, the rotation speed of the vehicle power generator 1 is detected by the rotation speed detection circuit 38. However, an engine rotation speed may be detected instead. In this instance, a circuit may be provided for detecting the engine rotation speed in the vehicle power generation control device 2 or the like. However, the engine rotation speed detected in the ECU 5 or the like may be acquired by the engine rotation speed being received by the communication control circuit 32.

In addition, in the example shown in FIG. 2, excitation current is large during low rotation and small during high rotation. However, the second excitation current upper limit value may be set such that the excitation current is small (such as 2 A) during low rotation corresponding to engine startup.

In addition, in the examples shown in FIG. 6 and FIG. 7, the maximum conduction ratio and the maximum excitation current value are changed with 1000 rpm as the border in both instances. However, the maximum conduction ratio and the maximum excitation current value may be changed with a single rotation speed or a plurality of rotation speeds other than 1000 rpm as the border.

As described above, in the embodiments, as a result of the first limit value being transmitted from an external device, restriction of the excitation current in the vehicle power generator 1 can be performed regardless of the magnitude of the second limit value held in the own device. Therefore, even when numerous combinations of vehicle power generators and vehicles are present, appropriate restriction of the power generation amount can be performed for each combination.

What is claimed is:

1. A vehicle power generation control device comprising:
communication means that receives a first limit value, related to restriction of an excitation current, when the first limit value is transmitted from an external device, the excitation current flowing to a field winding of a vehicle power generator;
excitation current control value determining means that determines a second limit value related to restriction of the excitation current to be a control value for the excitation current, the second limit value being stored in an own vehicle power generation control device, the excitation current control value determining means determining the first limit value to be the control value, instead of the second limit value being the control value, when the first limit value is received by the communication means; and
excitation current control means that controls the excitation current flowing to the field winding, based on the control value that has been determined by the excitation current control value determining means.

2. The vehicle power generation control device according to claim 1, wherein
the excitation current control value determining means determines the second limit value to be the control value, when information indicating that the excitation current is not to be restricted is received from the external device.

3. The vehicle power generation control device according to claim 1, wherein
the excitation current control value determining means determines the second limit value to be the control value, when communication between the external device and the communication means is interrupted.

4. The vehicle power generation control device according to claim 1, wherein
the second limit value is an upper limit value of the excitation current.

5. The vehicle power generation control device according to claim 1, wherein
the second limit value is an upper limit value of a conduction ratio of the field winding.

6. The vehicle power generation control device according to claim 1, wherein
the first limit value is an upper limit value of the excitation current.

7. The vehicle power generation control device according to claim 1, wherein
the first limit value an upper limit value of a conduction ratio of the field winding.

8. The vehicle power generation control device according to claim 1, further comprising
rotation speed detection means that detects a rotation speed of the vehicle power generator or an engine that drives the vehicle power generator,
the second limit value including a value based on the rotation speed detected by the rotation speed detection means.

9. The vehicle power generation control device according to claim 2, wherein
the excitation current control value determining means determines the second limit value to be the control value, when communication between the external device and the communication means is interrupted.

10. The vehicle power generation control device according to claim 2, wherein
the second limit value is an upper limit value of the excitation current.

11. The vehicle power generation control device according to claim 2, wherein
the second limit value is an upper limit value of a conduction ratio of the field winding.

12. The vehicle power generation control device according to claim 2, wherein
the first limit value is an upper limit value of the excitation current.

13. The vehicle power generation control device according to claim 2, wherein
the first limit value is an upper limit value of a conduction ratio of the field winding.

14. The vehicle power generation control device according to claim 2, further comprising
rotation speed detection means that detects a rotation speed of the vehicle power generator or an engine that drives the vehicle power generator,
the second limit value including a value based on the rotation speed detected by the rotation speed detection means.

15. The vehicle power generation control device according to claim 3, wherein
the second limit value is an upper limit value of the excitation current.

16. The vehicle power generation control device according to claim 3, wherein
the second limit value is an upper limit value of a conduction ratio of the field winding.

17. The vehicle power generation control device according to claim 3, wherein
the first limit value is an upper limit value of the excitation current.

18. The vehicle power generation control device according to claim 3, wherein
the first limit value an upper limit value of a conduction ratio of the field winding.

19. The vehicle power generation control device according to claim 3, further comprising
rotation speed detection means that detects a rotation speed of the vehicle power generator or an engine that drives the vehicle power generator,
the second limit value including a value based on the rotation speed detected by the rotation speed detection means.

20. A vehicle power generator comprising:
a field winding that generates a magnetic field;
an armature winding that generates electromotive force due to the magnetic field generated by the field winding to induce an alternating-current output;
a rectifying device that rectifies the alternating-current output from the armature winding;
a vehicle power generation control device comprising:
communication means that receives a first limit value, related to restriction of an excitation current flowing to the field winding, when the first limit value is transmitted from an external device;
excitation current control value determining means that determines a second limit value, related to restriction of the excitation current to be a control value for the excitation current, the second limit value being stored in an own vehicle power generation control device, the excitation current control value determining means determining the first limit value to be the control value, instead of the second limit value being the control value, when the first limit value is received by the communication means; and
excitation current control means that controls the excitation current flowing to the field winding, based on the control value that has been determined by the excitation current control value determining means.
